(19) United States
(12) Patent Application Publication
(10) Pub. No.: US 2025/0241376 A1
(43) Pub. Date: Jul. 31, 2025

(54) Aerosol Generating Device with an Orientation Sensor

(71) Applicant: JT International SA, Geneva (CH)

(72) Inventor: Layth Sliman Bouchuiguir, Bellevue (CH)

(73) Assignee: JT International SA, Geneva (CH)

(21) Appl. No.: 18/705,267

(22) PCT Filed: Nov. 24, 2022
(86) PCT No.: PCT/EP2022/083092

§ 371 Date: Apr. 26, 2024

(30) Foreign Application Priority Data
Nov. 26, 2021 (EP) 21210709.8

(51) Int. Cl. A24F 40/51; A24F 40/20; A24F 40/53; A24F 40/60

(52) U.S. Cl. CPC A24F 40/51; A24F 40/20; A24F 40/53; A24F 40/60

(57) ABSTRACT

An aerosol generating device includes an orientation sensor which is configured to detect the orientation of the device, a user interface which is configured to receive user inputs and a controller which is configured to enable or disable the user interface. The controller is configured to enable the user interface to accept user inputs when the detected orientation of the device is determined to be within a predefined orientation range. The controller is further configured to disable the user interface when the detected orientation is determined to be outside of the predefined orientation range.

### FIELD

The present invention relates to an aerosol generating device. In particular, the invention relates to an aerosol generating device with an orientation sensor for improved safety.

### BACKGROUND

There is a demand for aerosol generating devices such as electronic cigarettes with improved safety and energy saving features. It is an object of the present invention to provide an aerosol generating device that can address some of these requirements.

### SUMMARY

According to an aspect of the present invention there is provided an aerosol generating device comprising: an orientation sensor configured to detect the orientation of the device; a user interface configured to receive user inputs; and a controller configured to enable the user interface to accept user inputs when the detected orientation of the device is determined to be within a predefined orientation range, and wherein the controller is further configured to disable the user interface when the detected orientation is determined to be outside of the predefined orientation range.

In this way, the safety of the device is improved because the user interface of the device cannot be activated unintentionally. The user interface will only accept inputs when the device is in a certain orientation which is preferably the typical orientation that corresponds to normal use. Therefore, the likelihood of the device being operated unintentionally is reduced when the device is not in an orientation that is associated with normal use, such as when the device is in a user's bag or pocket. Advantageously the device remains in an active state when the user interface is disabled and can continue to perform other functions, such as communication with a user's phone using Bluetooth; however, the user interface of the device is disabled.

Preferably, the controller is configured to enable the user interface to accept user inputs when the detected orientation of the device is determined to be within the predefined orientation range for a predefined time period.

In this way, the safety of the device is further improved because the user interface will only accept inputs when the device is maintained in a certain orientation for a certain amount of time which can also be indicative of normal use in a user's hand. The device would not be activated if it were to be within the predefined orientation range temporarily, for a period of time that is less than the predefined time period, as might happen if the device were stowed in a bag which was in motion. This can also improve the energy efficiency of the device because it is not activated if it only with the predefined orientation range temporarily.

Preferably, the user interface is configured to operate a heating function of the device. In this way, the user may indicate when they wish to produce an aerosol using the heating function of the device, which is possibly only when the device is in the predefined orientation range. This improves the safety of the device as the user must make a conscious decision to operate the heating function of the device. The heating function is less likely to be operated by accident, therefore.

Preferably, the user interface comprises a button. In this way, the user must actively engage with the device in order to operate it, reducing the possibility of the device being activated unintentionally when being carried in a bag or pocket or the like, which can easily occur with a push-button.

Preferably, the orientation sensor comprises a gyroscope. In this way, the orientation of the device may be detected precisely.

Preferably the predefined orientation range comprises orientations where the longitudinal axis of the device is confined within a cone defined around a vertical axis. In this way, the user interface can be enabled when it is in an orientation that is mostly likely to correspond with an orientation of intended use. It is understood that users can hold aerosol generation devices in a number of different ways, and can hold the devices differently in different contexts. However, it has been found that the vast majority of intended uses of the device correspond to instances where the device is held such that its longitudinal axis is within a cone that is defined around the vertical axis.

The angle subtended by the cone and the vertical axis may be at least 20 degrees, and in some instances at least 40 degrees or 60 degrees, and most preferably at least 80 degrees. It has been found that this can accommodate the vast majority of different styles of use in different contexts from a wide number of different user types.

Preferably the device comprises a mouthpiece, and the predefined orientation is where the mouthpiece is pointing upward. In this context “upward” is intended to mean that the longitudinal axis of the device extends through mouthpiece such that it is inclined upwardly with respect to a horizontal plane. For most scenarios this is the preferred orientation of the device, in use.

Preferably, the device is configured to receive a consumable for heating. In this way, the device may be used for heating a plurality of aerosol forming substances. The consumable may comprise a tobacco substrate which may be solid or semi-solid that can be heated without burning. In alternative scenarios the consumable may comprise other kinds of substrate such as a vaporisable liquid substrate held in a reservoir.

Preferably, the device comprises an opening, the opening is configured to receive a solid consumable and the predefined orientation is where the opening is pointing upward. In this way, the device may be used for heating a plurality of solid aerosol forming substances that the user may insert into the device.

Preferably, the controller is configured to disable the user interface immediately when the detected orientation is determined to be outside of the predefined orientation range. In this way, the safety of the device is greatly improved as it is configured to disable the user interface as soon as the user no longer wishes to operate the device at the end of their session or accidentally mishandles the device. In this context, “immediate” is intended to mean without any delay that is deliberately introduced by design.

According to another aspect of the invention there is provided a method for using an aerosol generating device, comprising: detecting the orientation of the device using an orientation sensor; enabling a user interface to accept user inputs using a controller when the detected orientation of the device is determined to be within a predefined orientation range; and disabling the user interface using the controller when the detected orientation is determined to be outside of the predefined orientation range.

According to yet another aspect of the invention there is provided a computer readable memory medium comprising executable instructions which, when executed by a computer, cause the computer to perform steps comprising: determining the orientation of the device based on data from an orientation sensor; enabling a user interface to accept user inputs using a controller when the detected orientation of the device is determined to be within a predefined orientation range; and disabling the user interface using the controller when the detected orientation is determined to be outside of the predefined orientation range.

### DESCRIPTION OF DRAWINGS

Embodiments of the invention are now described, by way of example, with reference to the drawings, in which:

FIG. 1 is a schematic diagram of a device in an embodiment of the invention;

FIG. 2 is a flowchart showing a control sequence in an embodiment of the invention;

FIG. 3 is a schematic diagram of a predefined orientation region in an embodiment of the invention;

FIG. 4 is a schematic diagram of a device in a first orientation in an embodiment of the invention;

FIG. 5 is a schematic diagram of the device shown in FIG. 4 in a second orientation; and

FIG. 6 is a schematic diagram of the device shown in FIG. 4 in a third orientation.

### DETAILED DESCRIPTION

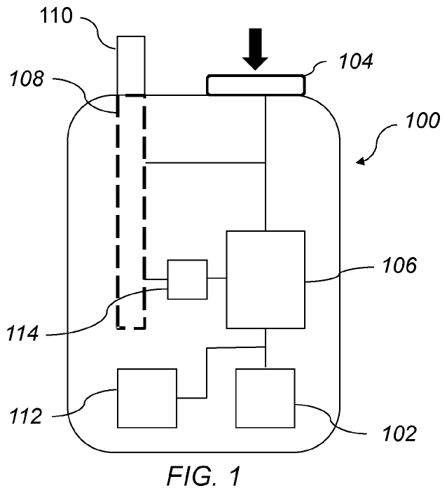

FIG. 1 is a schematic diagram of an aerosol generating device 100 in an embodiment of the invention. The aerosol generating device 100 comprises an orientation sensor 102 configured to detect the orientation of the aerosol generating device 100, a user interface 104 configured to receive user inputs and operate components of the aerosol generating device 100, a controller 106, a heater 108 configured to heat a consumable 110, a data storage medium 112 and a battery 114 configured to provide power to the components of the aerosol generating device 100.

The orientation sensor 102 is configured to detect the orientation of the aerosol generating device 100. More specifically, the orientation sensor 102 is configured to measure the angle subtended by the longitudinal axis of the device relative to a vertical axis.

The orientation sensor 102 can comprise one or more sensors, as would be understood by a person skilled in the art. Examples of appropriate sensors include, but are not limited to, a gyroscope, an accelerometer, a magnetometer or any combination thereof. The orientation sensor 102 is logically connected to the controller 106. The orientation sensor 102 is configured to provide a continuous stream of data to the controller 106 indicating time-series orientation data. The frequency with which orientation data are provided by the orientation sensor 102 is a design feature.

The user interface 104 is configured to receive user inputs and operate components of the aerosol generating device 100. More specifically, the user interface 104 is configured to operate the heater 108. The user interface 104 comprises any interface appropriate for receiving user inputs. Examples of appropriate interfaces include any combination of a button, a switch, a touch screen or any other method of receiving a recognisable input from a user. It is common that user interfaces like these can be activated accidentally such as when they are in a user's pocket or bag.

The controller 106 is configured to receive data from the orientation sensor 102 and configured to enable or disable the user interface 104. The controller 106 comprises a timing function so that it can determine a time period that the aerosol generating device 100 has been in a particular orientation. The controller 106 is a microcontroller in preferred embodiments.

The heater 108 is configured to heat a consumable 110 wherein the consumable 110 comprises an aerosol generating substance. The aerosol generating substance may comprise a tobacco substrate which may be solid or semi-solid that can be heated without burning. In alternative scenarios the consumable 110 may comprise other kinds of substrate such as a vaporisable liquid substrate held in a reservoir.

In the case where the aerosol generating device 100 is a heat-not-burn device, the heater 108 may be further configured to heat a solid consumable 110 received through an opening. The solid consumable 110 may comprise shredded tobacco. Solid consumables known in the art may comprise a mouthpiece portion or simply an end from which the user may inhale an aerosol.

The heater 108 may comprise any of an electrically resistive heater, a convective heater, an inductive heater, a laser heater, or any heating device known in the art. The skilled person would understand that the heater 108 may comprise a plurality of heating stages such as a preheating stage and a main heating stage. The user interface 104 is configured to activate the heater 108 to be in a particular heating stage.

The data storage medium 112 is configured to store data from components of the aerosol generating device 100. The data storage medium 112 may comprise a RAM or ROM storage device or a similar device known by the skilled person. The controller 106 may comprise the data storage medium 112 as is well known in the art.

In an embodiment of the invention the data storage medium 112 may be configured to store data regarding a predefined orientation range of the aerosol generating device 100 and or a predefined time period that the aerosol generating device 100 must be in a particular orientation. The controller 106 is logically connected to the data storage medium 112 and is configured to access data from the data storage medium 112 and the orientation sensor 102.

The battery 114 is configured to provide power to components of the aerosol generating device 100. The battery 114 may comprise a replaceable alkaline battery, a rechargeable lithium ion battery or the like known by the skilled person.

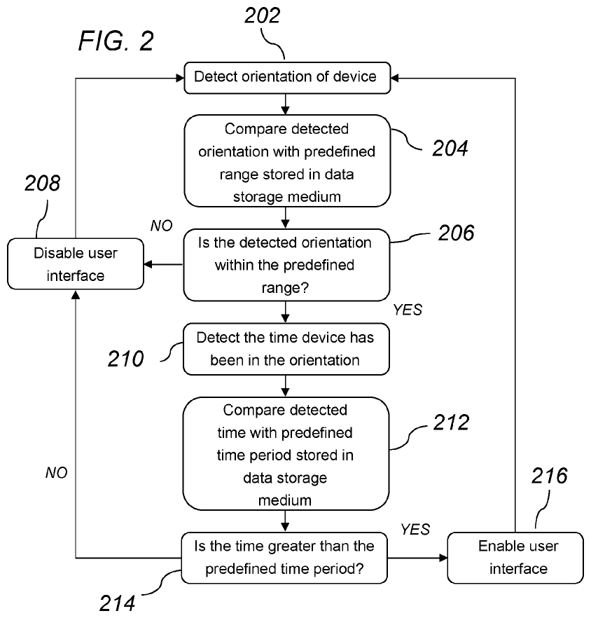

FIG. 2 is a flowchart showing a control sequence in an embodiment of the invention. At step 202, the orientation sensor 102 detects the orientation of the aerosol generating device 100. The orientation sensor 102 is configured to provide a continuous stream of data to the controller 106 indicating time-series orientation data. Data regarding the current orientation of the aerosol generating device 100 is fed to the controller 106 from the orientation sensor 102. The orientation data may be presented in a variety of formats including, for example, polar coordinates for the longitudinal axis of the device with respect to a vertical axis, or simply an angle subtended by the longitudinal axis of the device and the vertical axis.

At step 204, the controller 106 receives data regarding the current orientation of the aerosol generating device 100 from the orientation sensor 102. The controller 106 is configured to read data stored in the data storage medium 112. The data storage medium 112 is configured to store data comprising a preferred operating range.

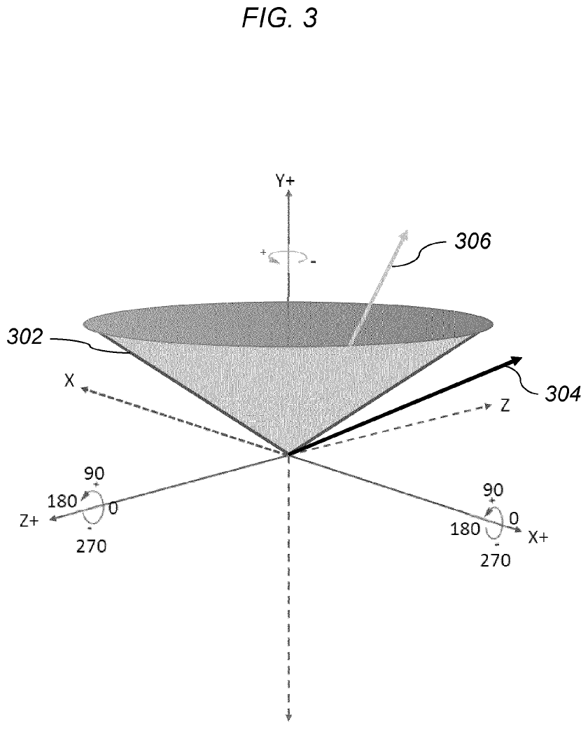

FIG. 3 is a schematic diagram of a predefined orientation range in an embodiment of the invention. In this example, the preferred operational orientation range is bounded by the surface of a cone 302 that is arranged about a vertical axis (in this case, the y-axis). The cone 302 in this example subtends an angle of 80 degrees with respect to the vertical axis. FIG. 3 shows a first example orientation 306 which is within the cone 302, and is therefore within the predefined orientation range. FIG. 3 also shows a second example orientation 304 which lies outside the bounding surface of the cone 302, and is therefore outside the predefined orientation range.

Data stored in the data storage medium 112 is indicative of the boundary of the predefined orientation range 302. This can simply be a matter of storing an angle in a polar or cylindrical coordinate system. In the example of FIG. 3 the angle subtended by the cone 302 is 80 degrees, but in alternative embodiments the angle may be 60 degrees, 40 degrees or 20 degrees.

At step 206, the controller 106 is configured to determine whether or not the detected orientation of the aerosol generating device 100 is within the predefined orientation range based on the comparison between the orientation data received from the orientation sensor 102 and the data comprising the predefined orientation range stored in the data storage medium 112.

If the controller 106 determines that the detected orientation of the aerosol generating device 100 is not within the predefined orientation range the controller 106 is configured to disable the user interface 104 immediately at step 208. In this context, “immediate” is intended to mean without any delay that is deliberately introduced by design. Once disabled, the user cannot provide the user interface 104 with user inputs and operate components of the aerosol generating device 100. Even though the user interface 104 is disabled, the device as a whole can remain active. For example, the device 100 may be available for other processing operations, and may be communicatively active with other third party devices such as the user's smartphone. However, the user interface 104 that is used for activating the heating function is advantageously disabled as a safety feature.

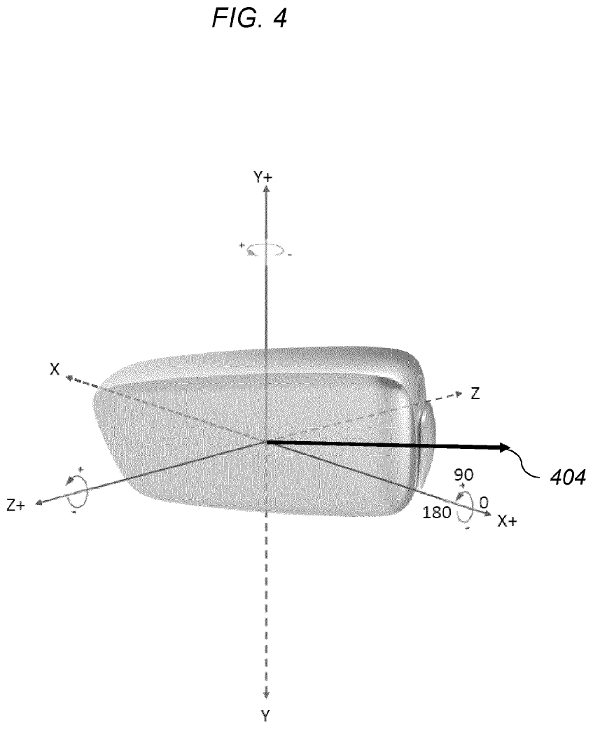

FIG. 4 is a schematic diagram of a device in a first orientation 404 in an embodiment of the invention. In the first orientation 404 the orientation of the aerosol generating device 100 is not within the predefined orientation range. Therefore, once this has been detected the controller 106 is configured to disable the user interface 104.

The controller 106 may disable the user input interface 104 by opening a switch (not shown) for example, preventing the transfer of signals from the user input interface 104 to components of the aerosol generating device 100. The skilled person would understand that numerous circuitry components know in the art may be used to achieve the desired disabling of the user input interface 104 by the controller 106.

In an alternative embodiment of the invention, the orientation sensor 102 may be configured to provide warning data to the controller 106 as soon as the orientation of the aerosol generating device 100 is detected to be outside of the predefined orientation range. A short time after receiving this warning data, the controller 106 disables the user input interface 104.

If the controller determines, at step 206, that the detected orientation of the aerosol generating device 100 is within the predefined orientation range the controller 106 is configured to detect the time period that the aerosol generating device 100 has been within the predefined orientation range at step 210. Thus, the controller 106 can start a timer as soon as it determines that the orientation of the device is within the predefined orientation range.

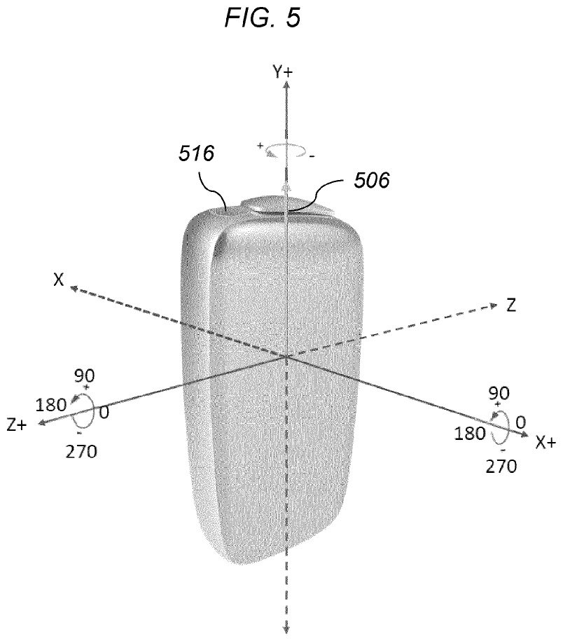

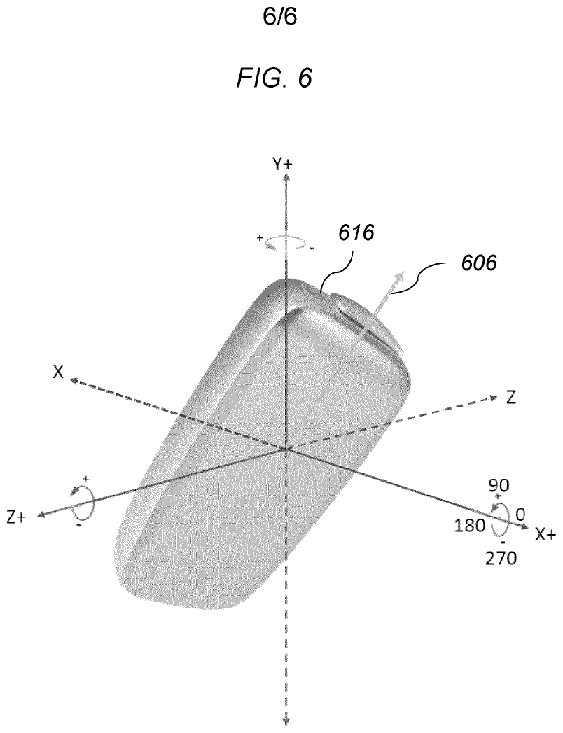

FIG. 5 and FIG. 6 are schematic diagrams of the device shown in FIG. 4 in a second orientation 506 and third orientation 606 respectively. In each of these orientations the orientation of the aerosol generating device 100 is within the predefined orientation range and thus the controller 106 is configured to detect the time period that the aerosol generating device 100 has been within the predefined orientation range. In each if these orientations, the mouthpiece 516 and 616 or the opening of the aerosol generating device 100 is orientated upwards (i.e. in the positive y-direction, extending through the horizontal x-z plane). The opening 516, 616 is configured to receive a tobacco stick a heat-not-burn device.

At step 212, the controller 106 is configured to compare the detected time period with a predefined time period stored in the data storage medium 112. At step 214, the controller 106 calculates whether the detected time period is greater than the predefined time period.

If the controller 106 calculates that the aerosol generating device 100 has been within the predefined orientation range for less than the predefined time period the controller 106 disables the user interface 104 at step 208 (or else maintains the user interface 104 in a disabled state). In this situation the user cannot provide the user interface 104 with user inputs and operate components of the aerosol generating device 100. In the case where the aerosol generating device 100 is a heat-not-burn device, this can prevent the device from being used to accidentally heat a consumable, since this would unnecessarily waste a consumable stick as well as battery energy.

If the controller 106 determines that the aerosol generating device 100 has been within the predefined orientation range for greater than the predefined time period then the controller 106 enables the user interface 104 at step 216. In this situation the user can provide the user interface 104 with user inputs and operate components of the aerosol generating device 100 such as the heater.

The controller 106 may enable the user input interface 104 by closing a switch (not shown) for example, allowing the transfer of signals from the user input interface 104 to components of the aerosol generating device 100. The skilled person would understand that numerous circuitry components know in the art may be used to achieve the desired enabling of the user input interface 104 by the controller 106.

At step 216, once the user interface has been enabled, the flow chart returns to step 202 so that the orientation sensor 102 can detect the orientation of the aerosol generating device 100. The frequency with which orientation data are provided by the orientation sensor 102 at step 202 is a design feature, and may be around 1 Hz in some embodiments.

1. An aerosol generating device, comprising:
an orientation sensor configured to detect the orientation of the device;
a user interface configured to receive user inputs, wherein the user interface is configured to operate a heating function of the device; and
a controller configured to enable the user interface to accept user inputs when the detected orientation of the device is determined to be within a predefined orientation range, and wherein the controller is further configured to disable the user interface when the detected orientation is determined to be outside of the predefined orientation range.

2. The aerosol generating device according to claim 1, wherein the controller is configured to enable the user interface to accept user inputs when the detected orientation of the device is determined to be within the predefined orientation range for a predefined time period.

3. The aerosol generating device according to claim 1, wherein the user interface comprises a button.

4. The aerosol generating device according to claim 1, wherein the orientation sensor comprises a gyroscope.

5. The aerosol generating device according to claim 1, wherein the predefined orientation range comprises orientations where the longitudinal axis of the device is confined within a cone defined around a vertical axis.

6. The aerosol generating device according to claim 5, wherein the angle subtended by the cone and the vertical axis is at least 60 degrees.

7. The aerosol generating device according to claim 5, further comprising a mouthpiece, and wherein the predefined orientation is where the mouthpiece is pointing upward.

8. The aerosol generating device according to claim 1, wherein the device is configured to receive a consumable for heating.

9. The aerosol generating device according to claim 1, further comprising an opening, wherein the opening is configured to receive a solid consumable, and wherein the predefined orientation is where the opening is pointing upward.

10. The aerosol generating device according to claim 1, wherein the controller is configured to disable the user interface immediately when the detected orientation is determined to be outside of the predefined orientation range.

11. A method for using an aerosol generating device, comprising:
detecting the orientation of the device using an orientation sensor;
enabling a user interface to accept user inputs using a controller when the detected orientation of the device is determined to be within a predefined orientation range, the user interface configured to operate a heating function of the device; and
disabling the user interface using the controller when the detected orientation is determined to be outside of the predefined orientation range.

12. A computer readable memory medium comprising executable instructions which, when executed by a computer, cause the computer to perform steps comprising:
determining the orientation of the device based on data from an orientation sensor;
enabling a user interface to accept user inputs using a controller when the detected orientation of the device is determined to be within a predefined orientation range, the user interface configured to operate a heating function of the device; and
disabling the user interface using the controller when the detected orientation is determined to be outside of the predefined orientation range.

13. The aerosol generating device according to claim 6, wherein the angle subtended by the cone and the vertical axis is at least 80 degrees.
